(19) United States
(12) Patent Application Publication
(10) Pub. No.: US 2021/0079987 A1
(43) Pub. Date: Mar. 18, 2021

(54) A SYSTEM FOR PROVIDING AUTOMATIC CONTINUOUSLY VARIABLE TRANSMISSION

(71) Applicant: PETER COOPER, BETHLEHEM, PA (US)

(72) Inventor: PETER COOPER, BETHLEHEM, PA (US)

(21) Appl. No.: 16/954,423

(22) PCT Filed: Dec. 14, 2018
(86) PCT No.: PCT/IB2018/060071

§ 371 Date: Jun. 16, 2020

Related U.S. Application Data
(60) Provisional application No. 62/607,250, filed on Dec. 18, 2017.

(51) Int. Cl. F16H 15/10; F16H 61/664; B62M 6/55; B62M 11/12; B62M 17/00

(52) U.S. Cl. CPC F16H 15/10; F16H 61/664; B62M 17/00; B62M 11/12; B62M 6/55

(57) ABSTRACT

Disclosed is a continuous variable transmission drive system for providing automatic continuously variable transmission for driving wheels of a vehicle. The vehicle includes wheels and either pedals or a motor. The continuous variable transmission drive system includes a drive shaft, a drive wheel, a drive disk, a sensor, a jack mechanism and a transmission unit. The drive shaft having a first end to receive a rotational force and a second end is connected to the drive wheel and moves along the drive shaft. The drive disk receives the power of the drive shaft from the drive wheel. The sensor for measuring compression force between the drive disk and the drive wheel. The jack mechanism applies variable compression force to control friction between the drive disk and the drive wheel. The transmission unit moves the drive wheel along the drive shaft, and changes ratio of angular velocity between the drive wheel and the drive disk to provide continuously variable transmission.

### CROSS REFERENCE TO RELATED APPLICATIONS

The present application is a national phase patent application of a PCT Application No. PCT/162018/060071 titled “A SYSTEM FOR PROVIDING AUTOMATIC CONTINUOUSLY VARIABLE TRANSMISSION” filed on Dec. 14, 2018, further the PCT Application claims priority of U.S. provisional application No. 62/607,250 titled “A SYSTEM FOR PROVIDING AUTOMATIC CONTINUOUSLY VARIABLE TRANSMISSION” filed on Dec. 18, 2017; which is incorporated herein by reference.

### BACKGROUND OF THE INVENTION

### 1. Field of the Invention

The present invention generally relates to a continuous variable transmission drive system for transforming power from the motor (or pedals) to the wheels, and more particularly relates to a continuous variable transmission drive system for providing automatic continuously variable transmission.

### 2. Description of Related Art

Bicycles and electric bikes (e-bikes) have only a few practical options for a drive system to transfer power from the motor (or pedals) to the wheels. The most commons ones include the derailleur, the hub gear and single speed bicycles (without any change in gears). Less common are continuous variable transmissions (CVTs) though many exist in the literature few are commercial successes, though the NuVinci™ is perhaps one.

Over the last few years' ebikes have increased in popularity due to the growing awareness of the environment and health issues. However, there is no drive system that ideally suits an ebike. The trend is towards mid-drive motors, as these provide a balanced ride and have the gear system behind the motor allowing the bike to shift down to a lower gear to climb hills.

In a fully automatic configuration a derailleur system requires that the power is removed from the drive chain when shifting, ebikes are motor driven and the power is always on, this results in noise and damage to the gears, especially in high powered ebikes such as those allowed in California where 1000 Watts is legal for a bicycle.

Also, as ebikes have more power and accelerate fast the gear system typically designed for bicycles can have gears “too close” making the rider repeatedly shift gears or skip gears to ensure they don't have to pedal too fast or too slow. Finally, they're a few ebikes that regenerate power from braking. There are a few bulky hub drives that regenerate but no (known) mid-drive ebikes that regenerate. Each of these drive systems has their positive and negative attributes: The derailleur is the most common, with low friction, high gear ratios and relatively low cost and lightweight.

However, derailleurs are notorious for inadvertent shifting, are noisy, vulnerable to dirt and sand and require the rider to manage the shift and reduce the pedaling forces while still pedaling to shift cleanly. Electronic shifters have entered the market for high-end road bikes and provide some performance improvements but are priced very high.

Hub gears are less common but have the advantage of being contained in the hub of the wheel, being sealed from dirt. However, hub gears like Sturmev Archer™ have relatively limited gearing range (except very expensive models like Rohloff™ at $US1200) and are heavier than derailleurs. Single speed chain drives have no shifting and therefore no ability to reduce the ratios for climbing steep hills.

The NuVinci™ CVT is a relatively new product being a hub mounted drive that have reasonably good gear range, is sealed from dust and dirt. It also has an automatic option so the rider does not have to switch gears manually; the gear ratio is set by electronics from the speed of the bicycle.

However, the NuVinci™ system is relatively expensive, heavy and, like all hub gears, increases the ‘unsprung weight’ and rotating inertia in the rear wheel and effects the bikes ride-ability, control and center of gravity adversely having weight on the rear of the bike. Also being a hub drive it is limited to only one hub size (at present) and limited to a maximum power of 350 W for ebikes.

All gear systems mounted on the wheels increase the unsprung weight of the bike. Unsprung weight refers to the weight of the bike that is not carried by the suspension system. High-un-sprung weights mean less efficient travel over terrain, as energy is lost as the un-sprung weight moves up and down over every bump. Conversely sprung weight maintains a more consistent travelling path and less energy is lost. All the gear systems mentioned increase the un-sprung weight with hub gears more so than derailleurs.

All these bicycle drive systems have a chain to transfer the pedal action to the back wheel, chains are vulnerable to dirt and water ingress, require maintenance and if unguarded can transfer grease to clothing. The Gates™ carbon drive is the exception, being a belt drive it is clean and durable, however more expensive and only works as a single speed requiring a hub gear as described above with the problems that solution presents. The last drive system of note is a shaft drive. Power transferred by a rotating shaft, is sealed from dust and dirt but again will only operate with a hub gear system if gear changing is needed.

Therefore, there is a need of system should be built around the use of a shaft drive. The principle of operation is a drive wheel that turns against a drive disk. The ratio can be varied by moving the drive wheel inwards towards the centre of the Drive disk for low ratios and outwards to the circumference of the Drive disk for higher ratios.

Further, the system should provide a bicycle gearing system that is low cost, low weight, robust and reliable, can be sealed from dirt, has a wide range of gearing, fits many bicycles, is continuously variable, fully automatic and in the case of ebikes can transfer high torque to and from the back wheel to support high power motors and regenerate energy back into the battery.

### SUMMARY OF THE INVENTION

In accordance with teachings of the present invention a continuous variable transmission system for providing variable transmission for driving wheels of a vehicle is provided.

An object of the present invention is to provide the continuous variable transmission drive system includes a drive shaft, a drive wheel, a drive disk, a sensor, a jack mechanism and a transmission unit. The drive shaft having a first end to receive a rotational force and a second end is connected to the drive wheel and moves along the drive shaft.

The drive disk receives the power of the drive shaft from the drive wheel. The sensor for measuring compression force between the drive disk and the drive wheel. The jack mechanism applies variable compression force to control friction between the drive disk and the drive wheel. The transmission unit moves the drive wheel along the drive shaft, and changes ratio of angular velocity between the drive wheel and the drive disk to provide continuously variable transmission.

Another object of the present invention is to provide the system with a servomotor to control the operation of the jack mechanism resulting in automatically adjusting the compression force, when the pressure is outside predetermined threshold values.

Another object of the present invention is to provide the system with a pressure cam for moving the drive wheel in and out from the drive disk and a pressure cable to control the pressure cam.

Another object of the present invention is to provide the system with a computer to analyze the compression force from the sensor, further the computer automatically operates the servomotor to supply pressure on the jack mechanism.

Another object of the present invention is to provide the system with a speed sensor for measuring the speed of the vehicle's wheel, and a torque sensor measures when a rider presses down on the pedals. Further, the torque sensor sends an instant signal to the computer, wherein the computer instructs the servomotor to change pressure between the drive wheel and the drive disk.

Another object of the present invention is to provide the system with a pressure wheel is connected to the drive shaft by the jack mechanism for providing opposing force against the drive disk opposite to the drive wheel, and a first lever configured on the vehicle to operate the pressure cable.

Another object of the present invention is to provide the system wherein the transmission unit includes a second lever configured on the vehicle, a gear shift cable attaches to the second lever to receive instructions for shifting gears, a gear shift coupler to move backwards and forwards in response to the movement of the gear shift cable, and a gear shift coupling rod to move the drive wheel in response to the movement of the gear shift coupler and the gear shift cable.

Another object of the present invention is to provide the system with comprising a second shift coupling rod to move the pressure wheel, a second drive wheel configured on a rear vehicle wheel attached to the drive shaft to receive the rotational force and a second drive disk connected to the pedals on the rear vehicle wheel.

Another object of the present invention is to provide the system wherein the drive shaft controls the movement of the second drive wheel to generate a wider gear ratio, and wherein the first drive wheel is tilted.

Another object of the present invention is to provide the system wherein the second drive wheel is tilted, and the first drive wheel and the second drive wheel are tilted. Further, wherein the drive disk is integrated in the vehicle's wheel to provide a greater gear ratio.

Another object of the present invention is to provide the system wherein the drive shaft is connected to a motor of the vehicle, and moves the first drive wheel and the second drive wheel independently.

### BRIEF DESCRIPTION OF DRAWINGS

FIG. 1 illustrates a perspective view of a typical shaft drive system in accordance with a preferred embodiment of the present invention;

FIG. 2 illustrates a side sectional view of the continuous variable transmission drive system showing usage of mechanical linkages to control gear ratio and drive wheel pressure to one side of the drive disk in accordance with another preferred embodiment of the present invention;

FIG. 3 illustrates a top sectional view of the continuous variable transmission drive system where the drive wheel is paired with a pressure wheel and pressure applied to both sides of the drive disk in accordance with a preferred embodiment of the present invention;

FIG. 4A illustrates a side sectional view of the continuous variable transmission drive system where the drive wheel tilts backward to steer it to a new position on the drive disk;

FIG. 4B illustrates a side sectional view of the continuous variable transmission drive system where the drive wheel tilts forward to steer it to a new position on the drive disk;

FIG. 5 illustrates a side sectional view of the continuous variable transmission drive system showing the drive disk forming part of the bicycle wheel rim's structure in accordance with another preferred embodiment of the present invention;

FIG. 6 illustrates a side sectional view showing another drive disk on the front of the continuous variable transmission drive system in accordance with another preferred embodiment of the present invention;

FIG. 7 illustrates another side sectional view showing the continuous variable transmission drive system with two drive disks and movement of the drive shaft by control of a lever in accordance with another preferred embodiment of the present invention;

FIG. 8 illustrates a side sectional view showing the continuous variable transmission drive system with two drive disks and independent movement of both drive wheels on splines in accordance with another preferred embodiment of the present invention;

FIG. 9 illustrates a side view showing the continuous variable transmission drive system with two drive disks with a pivotal joint in accordance with another preferred embodiment of the present invention.

### DETAILED DESCRIPTION OF DRAWINGS

While this technology is illustrated and described in a preferred embodiment, a continuous variable transmission drive system for driving a vehicle may be produced in many different configurations, shape, sizes and forms. This is depicted in the drawings, and will herein be described in detail, as a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the technology described herein.

The present invention is based upon, variability of the pressure ensures that the minimum pressure is applied for the given loads, meaning minimum drag. For example, when the rider is pushing hard the pressure increases, when cruising less pressure in applied, and very low pressure applied or completely released from contact when travelling down hills and when shifting gear ratios.

Varying the pressure to the needs of the rider means the drive is always optimizing for the minimum drag for the load conditions. The success of the drive requires that the drive wheel is designed with a high friction surface in the one direction to transfer the drive forces, but less friction to change ratios.

The drive wheel may be designed is with ridges radiating radially outwards on the drive disk and/or ridges in the drive wheel across the wheel for high friction in the in the drive direction but low across the wheel. Also, the pressure that is applied to the drive wheel against the drive disk may be varied and ensures that power is transferred when under high torque loads or less pressure under low loads.

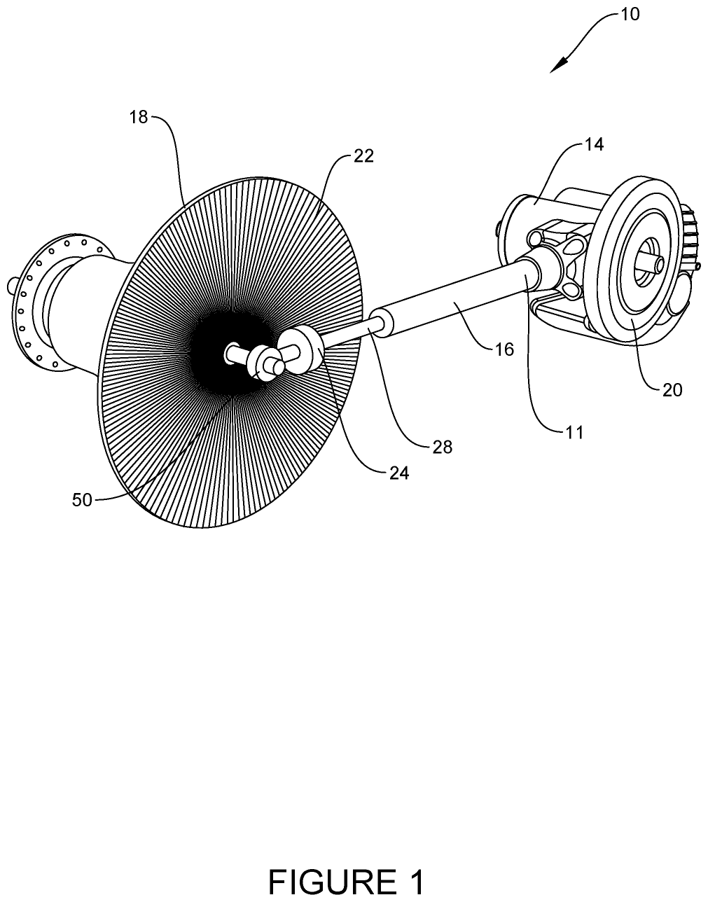

A continuous variable transmission drive system FIG. 1 is chosen as this provides a drive in the correct orientation. FIG. 1 illustrates a perspective view of a continuous variable transmission drive system 10 in accordance with a preferred embodiment of the present invention. The drive system 10 drives the wheels of a vehicle.

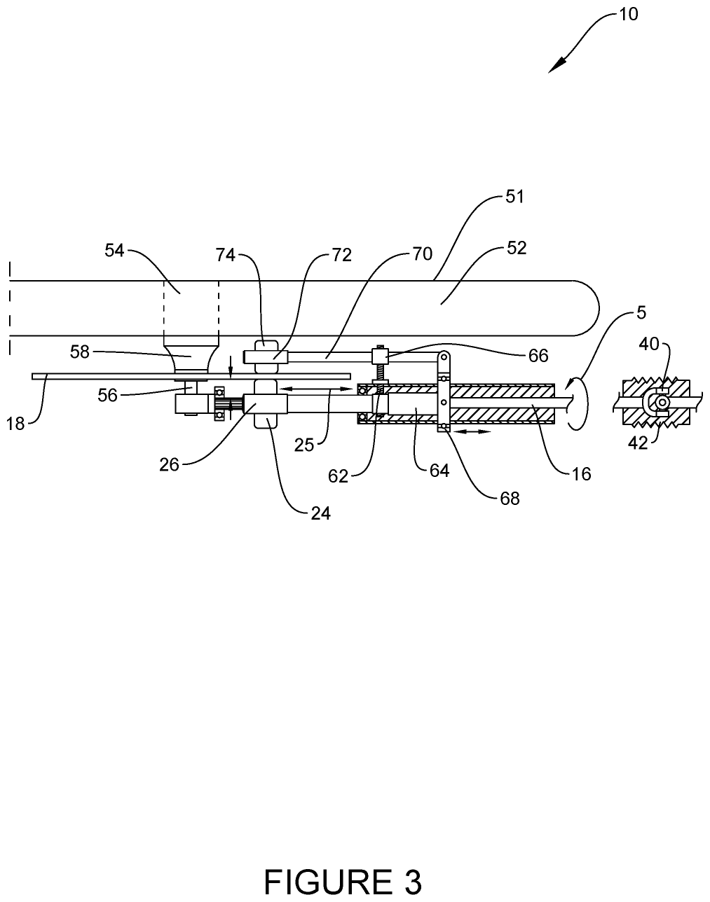

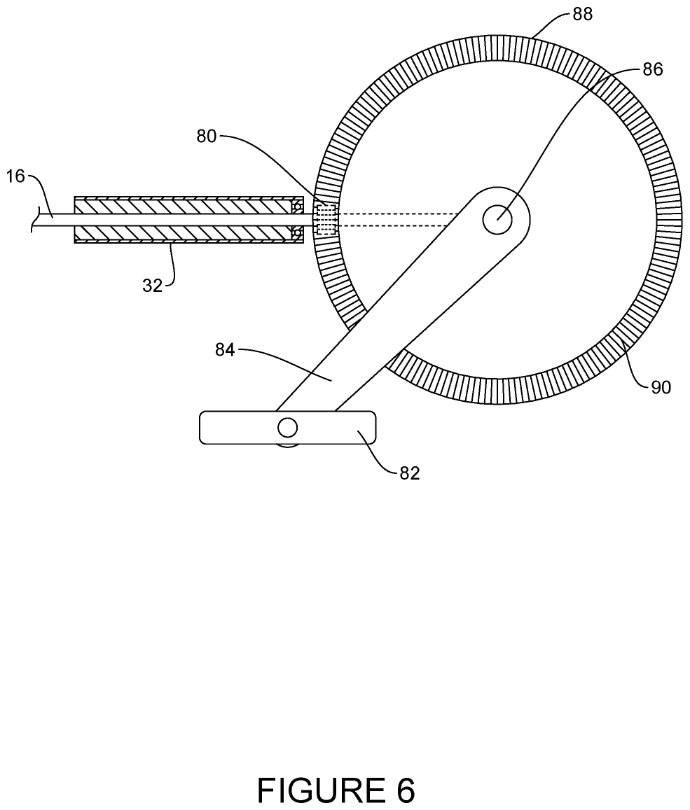

The vehicle generally includes the wheels (51, shown in FIG. 3) and pedals (82, shown in FIG. 6) or motor 14. Examples of the vehicle include but not limited to e-bikes, bikes, tri-bikes, quad-bikes, electric bikes, e-scooters, electric scooter, bicycle, tricycle and other similar types of vehicles.

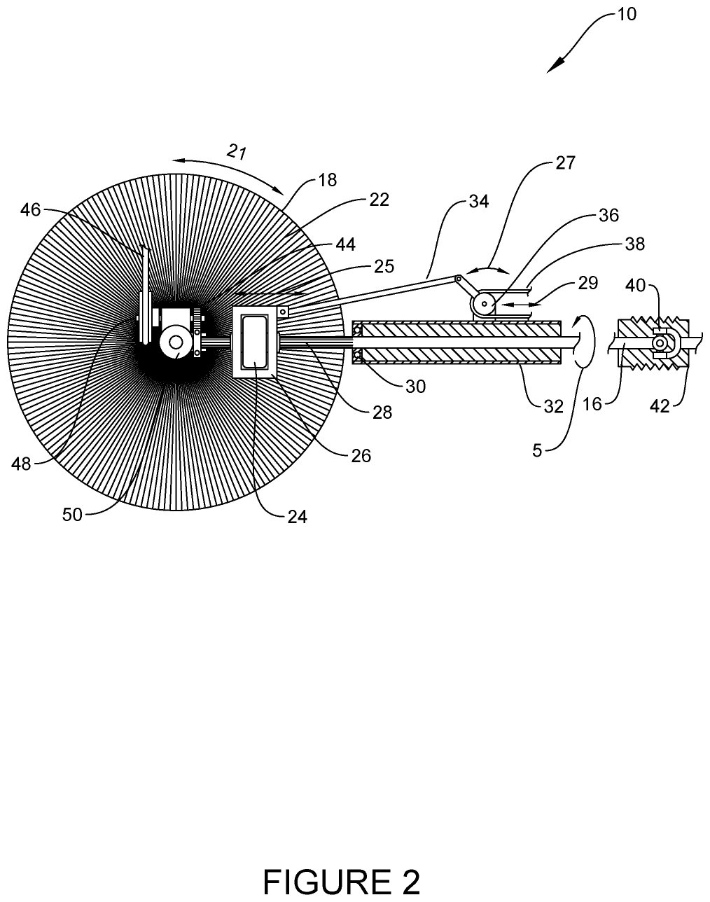

The continuous variable transmission drive system 10 includes a drive shaft 16, a drive wheel 24, a drive disk 18, a sensor (44, shown in FIG. 2), a jack mechanism (62, shown in FIG. 3), and a transmission unit (34, shown in FIG. 2). The drive shaft 16 having a first end 11 and a second end 28 (hereinafter also termed as spline 28). The first end 11 is connected to either pedals or motor 14; to receive rotational force.

The continuously variable transmission system 10 has the advantage of being oriented in a manner that correctly applies the drive wheel 24 to the drive disk 18. The drive shaft 16 may have a first end 11 and a second end 28. A motor 14 may be connected to the first end 11 and the motor 14 may have a chain ring housing 20 for housing a chain ring.

Charging a dynamo and/or a battery may occur when the rider engages the brakes or by means of a separate Regeneration ‘Regen’ lever for manual operation or automatically or both. Regeneration may provide a means to add energy into the battery whilst riding the bike when slowing down, controlling speed on steep down hills and/or stopping. Adding energy back into the battery extends the useful lifetime of the battery and increases the range of the ebike before the battery runs out.

The drive wheel 24 is connected to the second end 28 of the drive shaft 16. The drive wheel 24 moves along the drive shaft 16. The drive disk 18 is connected to the vehicle's wheel (51, shown in FIG. 3). The drive disk 18 receives the power of the drive shaft 16 from the drive wheel 24.

The pressure of the drive wheel 24 on the drive disk 18 and the position of the drive wheel 24 on the drive disk 18 may be controlled in a manual, mechanically aided or fully automatic fashion. In the manual case, the rider may have levers (not shown in FIGURES, to apply pressure) or an adjusting dial on the handlebars.

The drive wheel 24 is a circular wheel made of a compliant material around the outer circumference and around a solid core having indents to receive the drive shaft 16. The drive disk 18 is a circular plate made of a solid material with a hole in the center to the receive the axle and mounting holes for fixing to the wheel's hub.

FIG. 2 illustrates a side sectional view of the continuous variable transmission drive system 10 showing usage of mechanical linkages to control gear ratio and drive wheel pressure to one side of the drive disk 18 in accordance with another preferred embodiment of the present invention.

The drive wheel 24 is connected to the second end 28 of the drive shaft 16. The continuous variable transmission drive system 10 includes a drive wheel cage 26 for supporting the drive wheel 24. The drive shaft 16 may be an axle passing through the center of the drive wheel 24 and the drive wheel cage 26.

The drive shaft 16 is an elongate tubular member. The elongate tubular member is configured inside a shaft housing 32 in which a spindle 28 may extend through. Further, the system 10 includes a bearing 30 to allow circular rotational movement of the drive shaft 16 within the shaft housing 32. The circular rotational movement of the drive shaft 16 is indicated by an arrow 5.

In another embodiment of the present invention, the continuous variable transmission system 10 further includes a pressure cam 48 for moving the drive wheel 24 in and out from the drive disk 18, a pressure cable 46 to control the pressure cam 48, and a first lever (not shown in FIGURES) configured on the vehicle to operate the pressure cable 46. Examples of the first lever include but not limited to thumb operated lever, automatic lever, finger operated, twist operated lever, a gear stick lever, etc.

In a preferred embodiment of the present invention, the transmission unit 34 includes a second lever (not shown in FIGURES) configured on the vehicle, a gear shift cable 38 is attached to the second lever to receive instructions for shifting gears, a gear shift coupler 36 for to move backwards and forwards in response to the movement of the gear shift cable 38, and a gear shift coupling rod 34 to move the drive wheel in response to the movement of the gear shift coupler 36 and the gear shift cable 38. The forward and backward movement of the gear shift cable 38 is shown by the arrow 29.

The drive wheel 24 may be extendable or traverse in a direction parallel to the longitudinal axis of the elongated drive shaft 16. If the drive is slipping, the rider may apply more pressure via the first lever. If the drive is providing too much drag, the rider may adjust for less pressure and therefore may produce less drag.

In another embodiment of the present invention, the gear shift coupling rod 34 is connected to the drive wheel cage 26 via a pivot joint. The pivotal movement of the coupling rod 34 is shown by arrow 27. The rotation of the gear shift coupling rod 34 towards the first end (11 shown in FIG. 1) of the drive shaft 16 through the use of the gear shift cable 38 may move the first drive wheel 24 and the first drive wheel cage 26 towards the first end 11 of the drive shaft 16.

The drive wheel 24 is engaged with the drive disk 18. The drive disk 18 may have ridges 22 extending radially outwards from the center of the first drive disk 18 (hereinafter also referred as rear disk). The ridges 22 may have a higher friction in the drive direction and the ridges 22 may have a lower friction across the drive disk 18. The lower friction across the drive disk 18 may be such that the rider may easily change gears by moving the drive wheel 24 closer to the center of the drive disk 18 or closer to the rim of the drive disk 18. The drive disk 18 may be composed of a material that may be strong and resilient to bending at a predetermined pressure threshold.

The pressure sensor 44 may sense the compression pressure of the drive wheel 24 to the drive disk 18. The pressure sensor 44 may comprise fasteners 50 for supporting the pressure cables 46. The pressure cable 46 controls the pressure cam 48.

When the pressure sensor 44 senses that the compression pressure between the drive wheel 24 and the drive disk 18 may be outside the predetermined pressure threshold, the pressure sensor 44 in communication with a processor may dynamically adjust the drive wheel's position and pressure towards the drive disk 18. The pressure sensor 44 may advantageously minimize the time at which the drive wheel 24 may be exerting a higher pressure threshold towards the drive disk 18.

FIG. 3 illustrates a top view of the continuous variable transmission drive system 10 where the drive wheel 24 is paired with a pressure wheel 74 and pressure applied to both sides of the drive disk 18 in accordance with a preferred embodiment of the present invention. The jack mechanism 62 applies variable compression force to control the friction between the drive disk 18 and the drive wheel 24.

The pressure wheel 74 is connected to the drive shaft 16 by the jack mechanism 62 for providing opposing force against the drive disk 18 opposite to the drive wheel 24. The pressure wheel 74 is a circular wheel made of a compliant material around the outer circumference and around a solid core having indents to receive the drive shaft 16. The pressure wheel 74 does not provide torque as in the case of the drive wheel 24. Further, the system 10 further includes a second shift coupling rod 70 to move the pressure wheel 74. The second shift coupling rod 70 is attached to the jack mechanism 62 via a coupler 66.

In another embodiment of the present invention, the continuous variable transmission system 10 further includes a servomotor 64 to control the operation of the jack mechanism 62 resulting in automatically adjusting the compression force when the pressure is outside predetermined threshold values.

The jack mechanism 62 is a hydraulic system for adjusting the drive wheel pressure to the drive disk. The jack mechanism is a jackscrew. The jack mechanism 62 is moved by the servomotor 64 for adjusting the drive wheel pressure to the drive disk 18. The jack mechanism 62 may squeeze or clamp the first drive wheel 24 and the pressure wheel 74 together similar to a brake pad system.

The clamping force between the drive wheel 24 and the pressure wheel 74 may be automatically or manually adjusted to suit the riding conditions. When the torque is high, if the rider is pedaling hard or the motor under full power the clamping force increases to reduce slippage. Under light loads, the clamping force may be reduced to lower friction.

In another embodiment of the present invention, the continuous variable transmission drive system 10 includes a computer (not shown in FIGURES) to analyze the compression force from the sensor (44 shown in FIG. 2). The computer (not shown in FIGURES) automatically operates the servomotor 62 to supply pressure on the jack mechanism 62.

Examples of the computer (not shown in FIGURES) include but not limited to a microcomputer, microcontroller etc. The computer that senses the bikes speed, and based on the wheel size and the rider preferences, may move the drive wheel 24 to offer the optimal ratio, which determines the position of the drive wheel 24.

The first lever may be controlled by the computer that may sense the speed of the drive wheel 24 and the drive disk 18. If any slippage may be detected between these two wheels then the pressure may be increased to prevent the slippage.

In another embodiment of the present invention, the continuous variable transmission drive system 10 includes a speed sensor (not shown in FIGURES) for measuring the speed of the vehicle's wheel 51. Further includes a torque sensor (not shown in FIGURES) that measures when a rider presses down on the pedals (82, shown in FIG. 6). The torque sensor sends an instant signal to the computer. The computer instructs the servomotor 64 to change pressure between the drive wheel 24 and the drive disk 18.

The speed sensor may sense the speed of rotation via the use of magnets. Magnets may be positioned approximately equidistant around the rim of the first drive disk 18. A magnetic sensor may sense the magnetic field of a magnet at the wheel when the magnet passes within a predetermined distance from each other. The signal produced from this type of magnetic interaction may be a ‘stepped’ signal in which the peak of the signal is when the magnets are closest to each other and no signal may be registered when the magnetic interaction is out of range from the magnetic sensor. The frequency of the ‘stepped’ magnetic signal may be used to calculate the rotational speed of the first drive disk 18 and/or the vehicle wheel 51.

Similarly, the drive shaft 16 may also have a second gear shift coupler 68. The second gear shift coupler 68 may have a gear shift coupling rod 34 with a first end and a second end, in which the first end of the gear shift coupling rod 34 may be connected to a second pivot joint while the second end of the first gear shift coupling rod 34 is connected via a pivot or hinge to a first end of a second shift coupling rod 70.

The second end of the second shift coupling rod 70 may be connected to the pressure wheel cage 74. It may be appreciated that the first drive disk 18 may have a first drive wheel engaging surface and a pressure wheel engaging surface (also refer to second drive wheel engaging surface), wherein the plane of the pressure wheel engaging surface may be between the plane of the first drive wheel engaging surface and the plane of the vehicle wheel 51.

It may be appreciated that when the first drive wheel 24 may be engaging at the first drive wheel engaging surface of the first drive disk 18, that the pressure wheel 74 may be directly engaging the pressure wheel engaging surface at a corresponding opposing position.

It may be an advantage to provide a pressure wheel 74 in this preferred embodiment to provide a corresponding pushing force against the force exerted when the first drive wheel may be engaging the first drive disk 18. By providing a corresponding pushing force from the pressure wheel 74, the drive disk 18 may be subjected to less bending stress compared to when only a first drive wheel 24 is used.

The drive disk 18 is connected to a flange 58 of the vehicle's wheel 51. The flange 58 is attached to a vehicle wheel's hub 54. Further, an axle 56 protrudes through the drive disk 18. The drive disk 18 rotates along at the same rotational velocity as the vehicle's wheel 51.

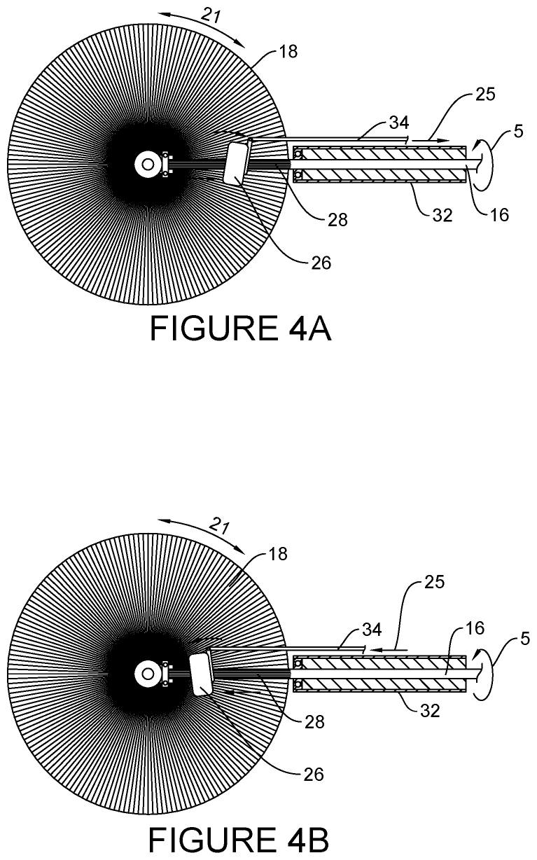

FIG. 4A illustrates a side sectional view of the continuous variable transmission drive system 10 where the drive wheel 24 tilts backward to steer it to a new position on the drive disk 18. FIG. 4B illustrates a side sectional view of the continuous variable transmission drive system 10 where the drive wheel 24 tilts forward to steer it to a new position on the drive disk 18.

FIGS. 4A and 4B illustrates how the drive wheels 24, 74 may be moved via a shift coupling rod 34, 70. When the shift coupling rod 34 pulls the first drive wheel cage 26 towards the first end 11 of the drive shaft 16, the first drive wheel 24 may also tilt toward the first end 11 of the drive shaft 16.

When the drive wheel is tilted toward the first end 11 of the drive shaft 16, the drive wheel 24 moves along the spline 28 towards the rim of the drive disk 18. When the shift coupling rod 34 pushes the first drive wheel cage 26 towards the second end 28 of the drive shaft 16, the first drive wheel 24 may also tilt toward the second end 28 of the draft shaft 16.

The drive may be made to tilt by means of a lever (not shown in FIGURES) attached to the drive wheel. Forwards tilt inclines on the drive wheel so that it tracks outwards on the drive disk to a low speed gear ratio. Conversely, a backwards incline and it tracks inwards to a high speed ratio.

This embodiment may have an advantage, as it does not require a motor to move the drive wheel with high force to a new position. But rather simply by tilting the drive wheel which may require much less force results in it tracking in or out as the drive disk rotates.

When the drive wheel 24 is tilted toward the second end 28 (hereinafter also referred as spline 28) of the drive shaft 16, the drive wheel 24 moves along the spline 28 towards the center of the drive disk 18. It may be appreciated that the drive disk 18 may be rotating in the direction indicated by 21 while the position of the drive wheel may be moved by the shift coupling rod 34.

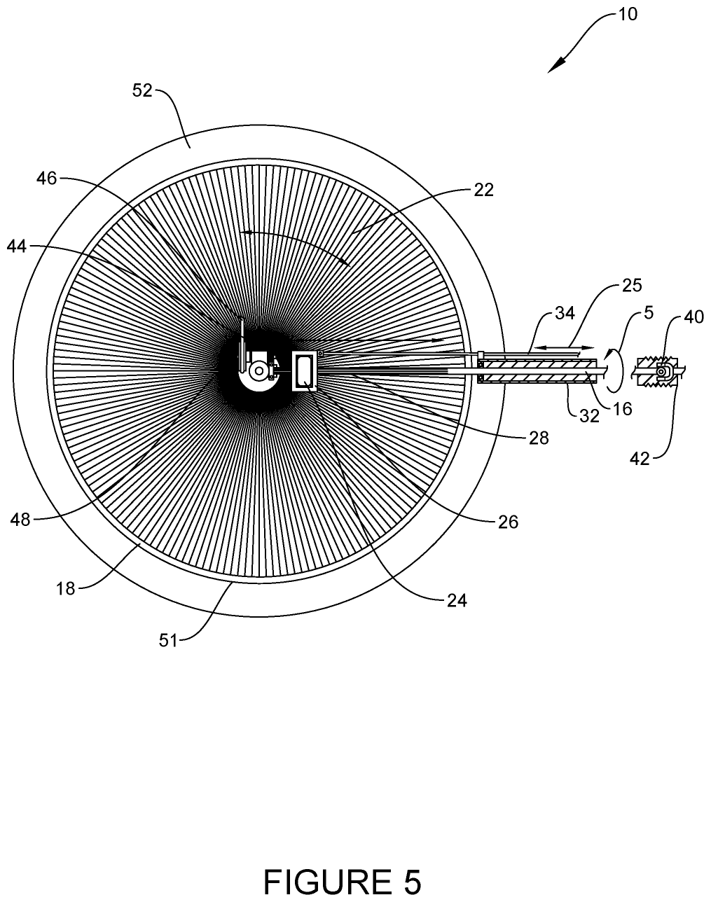

FIG. 5 illustrates a side sectional view of the continuous variable transmission drive system 10 showing the drive disk 18 forming part of the bicycle wheel 51 rim's structure 52 in accordance with another preferred embodiment of the present invention. The drive disk 18 is integrated in the vehicle's wheel 51 to provide a greater gear ratio. The transmission system 34 moves forward and backward as shown by arrow 25 to move the drive wheel 24.

This may remove the necessity to have the drive disk 18 and would allow the drive wheel 24 freedom to move from the bike's wheel 52 to the wheel rim 51. Such a configuration may have the advantage of allowing a much higher ratio for climbing very steep hills slowly and having a gear range as high as 1000%.

In another embodiment of the present invention, the system 10 further includes a seal 42 for covering the universal joint to limit water and dirt ingress, though this may not be needed in all cases. The seal 42 may be an IP65 seal similar to e-bike motors allows the system 10 to be used in wet environments including beaches, in wet weather or even full immersion in shallow water.

The seal 42 prevents the ingress of solids and fluids to the device 10. It may be appreciated that the sealed casing 42 may be constructed from a material that is breathable to allow for heat from the running of the motor and the heat of the battery to escape the system 10. The seal casing 42 is attached to the drive shaft 16 with a bracket 40.

FIG. 6 illustrates a side sectional view showing another drive disk 88 on the front of the continuous variable transmission drive system 10 in accordance with another preferred embodiment of the present invention. The system 10 further includes a second drive wheel 80 configured to the drive shaft 16 around the second end (11 shown in FIG. 1) to receive the rotational force, and a second drive disk 88 connected to the pedals 82.

It would be readily apparent to those skilled in the art that the second drive disk 88 may be attached to the motor (14, shown in FIG. 1) without deviating from the scope of the present invention. The second drive disk 88 (hereinafter also referred as front disk) at the first end 11 of the drive shaft 16, in which the second drive disk 88 may be attached in place of a typical chain ring. Further, a bearing 86 is configured to attach the pedals 82 to the drive shaft 16.

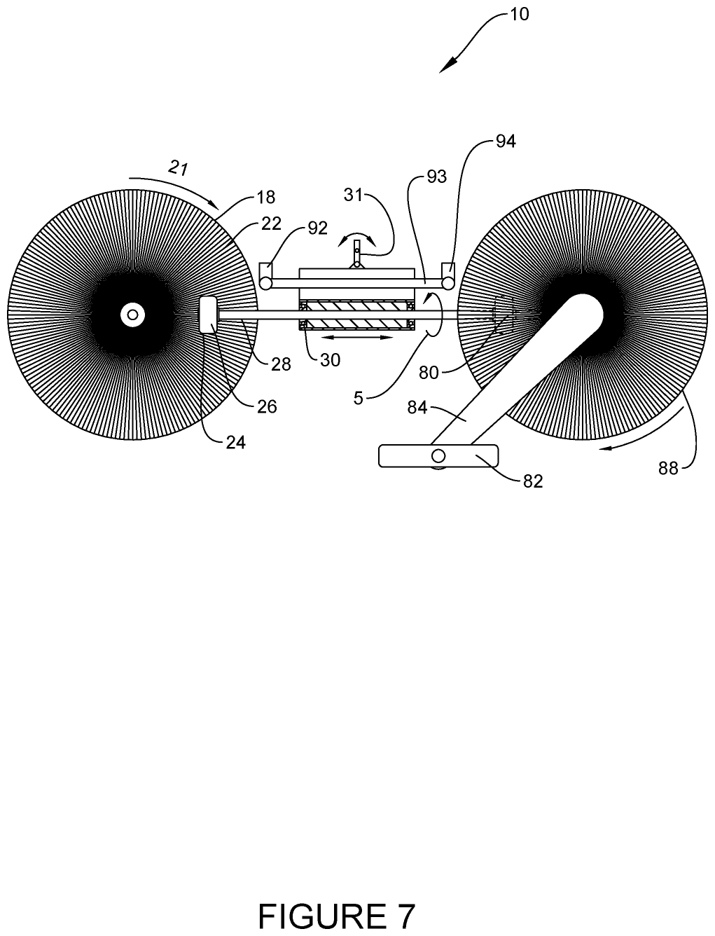

FIG. 7 illustrates another side sectional view showing the continuous variable transmission drive system 10 with two drive disks 18, 88 and movement of the drive shaft 16 by control of a single lever 31 in accordance with another preferred embodiment of the present invention. As illustrated in FIGS. 6 and 7, the drive wheel 80 are positioned on the inside of the second drive disk 88 which may ensure the correct rotation direction of the second drive disk 88.

The opposite configuration may also be implemented, however, the drive wheel 80 may be on the outside of the second drive disk 88. When the drive wheel 80 is on the outside of the second drive disk 88, it may create a bumping or scratching hazard to the rider as the rider's limbs are moving when the rider's foot is situated on the pedal 82 when pedaling or rotating the pedal crank arm 84 when riding the bicycle.

The drive wheel 24 may engage with the drive disk 18 and the drive wheel 80 may engage with the second drive disk 88. The drive disks 18, 88 may have ridges 22, 90 respectively extending radially outwards from the center of the drive disks 18, 88. The ridges 22, 90 may have a higher friction in the drive direction and the ridges 22, 90 may have a lower friction across the drive disks 18, 88.

The lower friction across the drive disks 18, 88 may be such that the rider may easily change gears by moving the drive wheels 24, 74 closer to the center of the drive disks 18. 88 or closer to the rim of the drive disk. The drive wheels 24, 74 may also have ridges 22, 90 that may track with the ridges 22, 90 on the drive disks 18, 88.

It may be appreciated that when the drive wheel 24, 74 engages with the drive disks 18, 88, that pressure is applied from the drive wheels 24, 74 to the drive disks 18, 88. The drive disks 18, 88 may be composed of a material that may be strong and resilient to bending at a predetermined pressure threshold.

The pressure sensor 44 may sense the compression pressure of the drive wheels 24, 74 to the drive disks 18, 88. When the pressure sensor 44 senses that the compression pressure between the drive wheels 24, 74 and the drive disks 18, 88 may be outside the predetermined pressure threshold.

The pressure sensor 44 in communication with a processor may dynamically adjust the drive wheel's 24, 74 position and pressure towards the drive disks 18, 88. The pressure sensor 44 may advantageously minimize the time at which the drive wheels 24, 74 may be exerting a higher pressure threshold towards the drive disks 18, 88.

In another preferred embodiment, as illustrated in FIG. 7, there may be a lever 31 that may be operated manually or automatically to change the gears. In the manual case, the rider has levers 31 or an adjusting dial on the handlebars. In the fully automatic case sensors, electronics and software control miniature motors or hydraulic actuators to adjust the pressure and the position. The system 10 includes a rod 93, and brackets 92, 94 to attach the lever 31 to the vehicle.

As shown in FIG. 7, the Gear and Cog are positioned on the inside of the Chain Ring Disk, in order to ensure the correct rotation direction. The opposite configuration may also be implemented, the Gear and Cog on the outside of the Disk. However, this may create a hazard to the rider, as their leg would brush past and may interfere with the Gear and Cog.

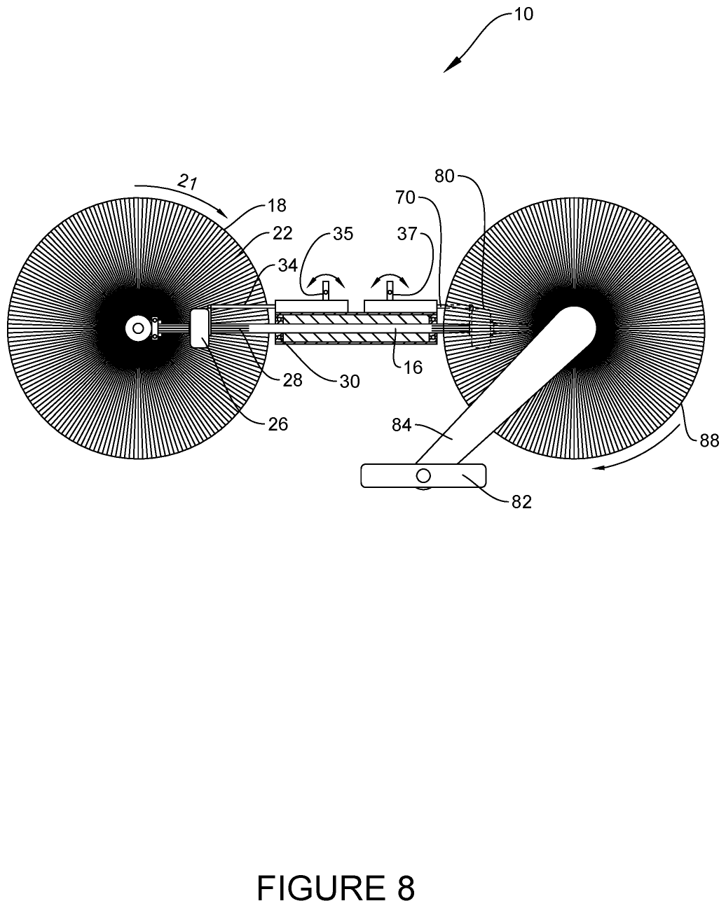

FIG. 8 illustrates a side sectional view showing the continuous variable transmission drive system 10 with two drive disks 18, 88 and independent movement of both drive wheels 26, 80 on splines 28 in accordance with another preferred embodiment of the present invention. The second disk 88 on the front of the drive system 10, attached in place of a typical chain ring in the same manner as the rear chain ring as shown in FIG. 7, the front chain ring disk may be attached to the crank and the drive wheel 80 is attached and it is driven by the chain ring disk.

A pressure wheel may be attached to the outside of the disk to allow the drive wheel to be pressed firmly against the disk. The front drive wheel 88 may be attached via a spline to the drive shaft 16, and then on to the rear drive wheel to drive the back wheel.

In another preferred embodiment, as illustrated in FIG. 8, there may be a lever 35 and a lever 37. The lever 35 may be independent to the lever 37. The lever 35 may control the gear shift coupling rod 34 while the lever 37 may control the gear shift coupling rod 34 for moving the drive wheel 80.

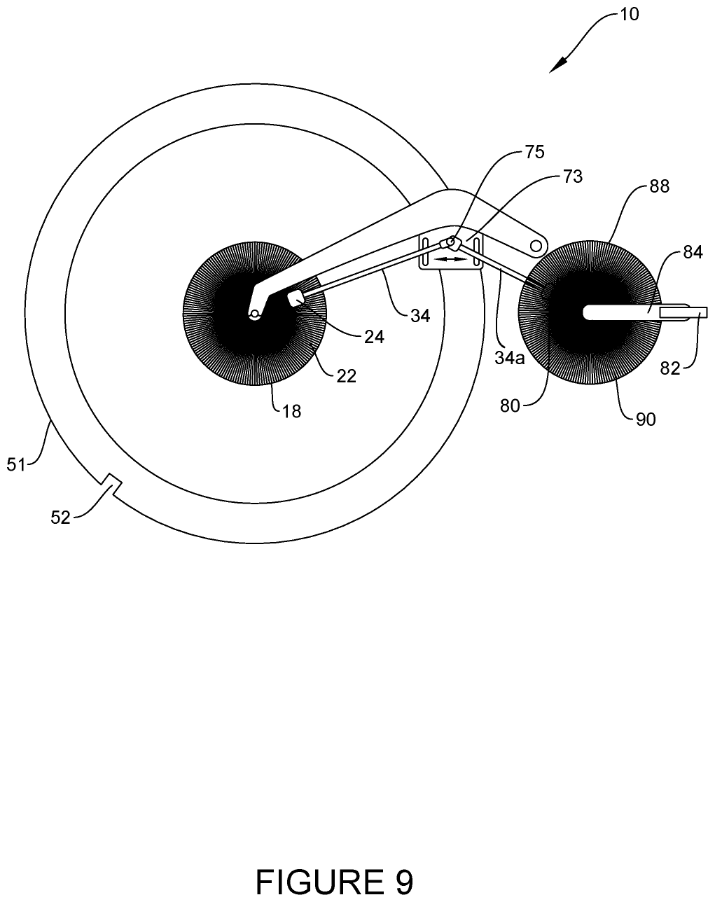

FIG. 9 depicts a side view showing the continuous variable transmission drive system 10 with two drive disk 18, 88 with a pivotal joint 75 in accordance with another preferred embodiment of the present invention. The drive disk 18 may be connected to the drive disk 88.

The drive wheel 24 may be connected to a gear shift coupling rod 34 and the drive wheel 80 may be connected to another gear shift coupling rod. The first gear shift coupling rod 34 may be connected using a pivot or a hinge 75 to the gear shift coupling rod 34a.

The pedaling of the drive disk 88 may rotate the drive wheel 80 which moves the gear shift coupling rod 34a, which moves the pivot or hinge 75 and may move the gear shift coupling rod 34, which moves the drive wheel 24 which may rotate the first drive disk 18. There may be a gear shift coupling cage 73 with a first aperture and a second aperture. The gear shift coupling rod 34 may pass through the first aperture and the second gear shift coupling rod may pass through the second aperture.

It may be appreciated that the apertures may have an ovular profile, wherein the longer axis of the ovular apertures are parallel to the tangent to the tire 52 of the vehicle wheel 51. It may be appreciated that in this preferred embodiment, the gear shift coupling rods may move along the longer axis of the ovular apertures. The gear shift coupling cage 73 may be in connection to the frame and may also provide support to the cage 73.

Regulations exist in most countries that limit the maximum power of e-bikes. This is a serious limitation in e-bikes when climbing steep hills. In the USA it varies by state with 750 Watts being typical of in Europe (and Australia) the EN15194 standard is 250 Watts. If the gearing is not sufficiently low, then the motor speed decreases, motor and battery currents increases, the motor operates in “high current” and the motor may stop completely known as a “stall”.

An embodiment of the continuously variable transmission system may overcome these limitations by providing a sufficiently low gear ratio to enable the motor to climb the hill without the motor slowing down to a “high current” or “stall”.

The following calculations demonstrate how the provides a wide gear range and therefore the ability to climb steep hills with the power limits imposed by regulations on the motor.

The following calculations depict the gear range in percent, based on embodiments using a single rear disk as depicted in FIG. 1 or 6.

Min running diameter of rear Disk (SG min): 50 mm

Max running diameter of rear Disk (SG max): 170 mm

$$\begin{matrix}Gear Range = ( SGmax - SGmin ) \text{/} SGmin * 100 \\ = ( ( 170 - 50 ) \text{/} 50 * 100 \\ = 240 \%\end{matrix}$$

As comparison a typical rear derailleur has a similar overall range, for example a Shimano™ 8-speed Sprocket has a low gear of 12 gear teeth and high gear teeth of 25

$$\begin{matrix}Gear r ange = high gear teeth \text{/} low gear teeth \\ = 25 \text{/} 12 * 100 \% \\ = 208 \%\end{matrix}$$

In this example the continuous variable transmission drive system 10 has a higher gear range. To offer even higher gear range the continuous variable transmission drive system 10 has 2 disks as depicted in FIG. 7, 8 or 9.

The running diameters are the path the drive wheel follows in the various positions on the front and rear disks

Min running diameter of front Disk (CRmin): 65 mm

Max running diameter of front Disk (CR max): 170 mm

Min running diameter of rear Disk (SG min): 170 mm

Max running diameter of rear Disk (SG max): 50 mm

Using the following equation:

$$\begin{matrix}Gear Range = ( CRmax - CRmin ) \text{/} CRmin + ( SGmax - SGmin ) \text{/} SGmin * 100 \\ = ( ( 170 - 65 ) \text{/} 65 + ( 170 - 50 ) \text{/} 50 ) * 100 \\ = 400 \%\end{matrix}$$

As described by these calculations above the continuously variable transmission system offers this wide range of gears for high speeds, low speeds and hill climbing with a limited power motor.

An important parameter for ebike is their range. Range has been a wildly overstated performance parameter, many ebikes state a range based on the maximum power at the maximum speed using an over simplified range equation:

Range (oversimplified)=Battery Watt Hour×Speed/Power

For a typical ebike we can use the parameters:

$$Battery Amp Hour = 550 WH$$

$$Speed = 25 kph$$

$$Power = 250 W$$

$$Range ( oversimplified ) = 550 \times 25 \text{/} 250 = 55 km$$

But this calculation does not consider the many variables most of that lower the actual speed including the efficiency of the drive system, air resistance and the losses in the drive system. In real cases a range of 25 km is more typical.

The continuously variable transmission system has the capability for regeneration. The combination of uphill and downhill, accelerating and stopping and moderate speeds means low losses in the system overall and high losses for short periods, motor and pedal efficiency and regeneration all combine to give a net positive range increase. The expected range in this case with regeneration would to be closer to 35 km, a significant improvement.

Further range improvements are expected in continuously variable transmission system due to the relationship between the drive wheel friction and the pressure, the more the pressure the more the friction.

The drive wheel deforms when in contact with the Drive disk is similar way that a car tire deforms slightly as it contacts the road. The loss is caused by hysteresis as the drive material is compressed and released, which heats the tire.

But when a bicycle is coasting along a flat road at low to moderate speeds the power required is low. In this case the drive wheel friction required is low, the drive wheel pressure can be low and the resulting losses are low. Also, materials are chosen that have high friction, low deformation and low hysteresis losses—therefore low overall losses.

Further in another preferred embodiment it would be evident to those skilled in the art that the microcomputer software on the microcomputer may be upgraded when newer versions of the software become available.

It may be appreciated that the term continuously variable transmission system may also include or be referred to as a drive shaft device. Although the invention has been described with reference to specific examples, it will be appreciated by those skilled in the art that the invention may be embodied in many other forms, in keeping with the broad principles and the spirit of the invention described herein. The present invention and the described preferred embodiments specifically include at least one feature that is industrial applicable.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others. The scope of the invention is indicated by the appended claims rather than by the foregoing description. All changes which come within the meaning and range of equivalency of the claims are to be embraced within their scope.

The claims defining the invention are as follows:

1. A device adapted for rotating a vehicle wheel, wherein the device comprises:
a drive shaft having a first end and a second end;
a motor connected to the first end, wherein the motor applies rotational force to the drive shaft;
a first drive wheel and a pressure wheel connected to the second end, wherein the first drive wheel and the pressure wheel are extendable in a direction parallel to the longitudinal axis of the drive shaft;
a drive disk having a first outer surface and a second outer surface, wherein the first drive wheel is adapted to engage with the first outer surface, and wherein the pressure wheel is adapted to engage with the second outer surface;
the first drive wheel and pressure wheel are adapted to engage with the drive disk, wherein the compression force of the first drive wheel to the drive disk is controlled by a pressure sensor, when the pressure is outside a predetermined pressure threshold, the sensor dynamically adjusts the positioning of the wheels to the drive disk;
the drive disk connected to the vehicle wheel, wherein the rotational movement of the drive wheels rotate the drive disk which rotates the vehicle wheel.

2. The device according to claim 1, wherein the pressure wheel is connected to the drive shaft by a jack mechanism.

3. The device according to claim 2, wherein the jack mechanism is a jackscrew.

4. The device according to claim 3, wherein the jackscrew is moved by a cable mechanism for adjusting the drive wheel pressure to the drive disk.

5. The device according to claim 2, wherein the jack mechanism is a hydraulic system for adjusting the drive wheel pressure to the drive disk.

6. The device according to claim 3, wherein the jackscrew is moved by the motor for adjusting the drive wheel pressure to the drive disk.

7. A device adapted for rotating a vehicle wheel, wherein the device comprises:
a drive shaft having a first end and a second end;
a motor connected to the first end, wherein the motor applies rotational force to the drive shaft;
a first drive wheel connected to the second end, wherein the first drive wheel is extendable in a direction parallel to the longitudinal axis of the drive shaft;
the first drive wheel is adapted to engage with the drive disk, wherein the compression force of the first drive wheel to the drive disk is controlled by a pressure sensor, when the pressure is outside a predetermined pressure threshold, the sensor dynamically adjusts the positioning of the first drive wheel to the drive disk;
the drive disk connected to the vehicle wheel, wherein the rotational movement of the first drive wheel rotates the drive disk which rotates the vehicle wheel.

8. The device according to any one of the preceding claims, comprising a linear gear, wherein the linear gear is adapted to move the drive shaft transverse to the longitudinal axis of the drive shaft.

9. The device according to any one of the preceding claims, comprising a lever, wherein the lever moves the drive wheel along the longitudinal axis of the drive shaft to change the gear ratio.

10. The device according to any one of the preceding claims, comprising a power source in electrical communication with the motor, wherein the motor is adapted to dynamically adjust the positioning of the drive wheel, and wherein the power source is adapted to operate the pressure sensor.

11. The device according to any one of the preceding claims, comprising a speed sensor for sensing the rotation speed of the vehicle wheel.

12. The device according to claim 11, comprising a processor, wherein the processor is in communication with the speed sensor, the processor is adapted to calculate and position the drive wheels.

13. The device according to claim 11 or claim 12, wherein the speed sensor is a magnetic sensor.

14. The device according to any one of the preceding claims, wherein the drive disk is positioned between the first drive wheel and the vehicle wheel.

15. A device adapted for rotating a vehicle wheel, wherein the device comprises:
a drive shaft having a first end and a second end;
a motor connected to the first end, wherein the motor applies rotational force to the drive shaft;
a first drive wheel connected to the second end, wherein the first drive wheel is extendable in a direction parallel to the longitudinal axis of the drive shaft;
the vehicle wheel comprising a drive disk;
the first drive wheel is adapted to engage with the drive disk, wherein the compression force of the first drive wheel to the drive disk is controlled by a pressure sensor, when the pressure is outside a predetermined pressure threshold, the sensor dynamically adjusts the positioning of the first drive wheel to the drive disk;
wherein the rotational movement of the first drive wheel rotates the vehicle wheel.

16. The device according to any one of the preceding claims, wherein the drive disk comprises a plurality of grip ridges radially extending from the centre of the drive disk.

17. A device adapted for rotating a vehicle wheel, wherein the device comprises:
a first disk attached to the vehicle wheel engaging a first drive wheel;
a second wheel is driven by a manual or electrical circular motion driver, wherein the first drive wheel is adapted to traverse radially along the first disk, such that a rotational ratio between the first disk and the motion driver is adjustable by traversing the first drive wheel radially along the first disk.

18. A device according to claim 17, wherein the second wheel engages with a second disk, and the second disk is attached to the motion driver, such that the second wheel is adapted to traverse radially along the second disk.

19. The device according to claim 18, wherein the first drive wheel is connected to the second drive wheel with a fixed length drive shaft.

20. The device according to claim 18, wherein the first drive wheel is connected to the second drive wheel with an adjustable length drive shaft, and the adjustable length drive shaft comprises one or more lever for adjusting a length between the first drive wheel and the second drive wheel.

21. The device according to claim 20, wherein the lever is controlled by any one or more of a jack motor, linear motor, cable mechanism, hydraulic actuator or actuation means.

22. The device according to claim 21, wherein the lever is controlled by a computer system in response to a speed of the vehicle wheel.

23. The device according to claim 17, further comprising
one or more intermediate drive disks, each of which is engaging with an in-coming drive wheel and an out-going drive wheel,
wherein the in-coming drive wheels and out-going drive wheels are adapted to traverse radially along an intermediate drive disk;
wherein each in-coming drive wheel is either connected to an out-going drive wheel or the second drive wheel; and each out-going drive wheel is either connected to an in-coming drive wheel or the first drive wheel;
such that a rotational ratio between the first disk and the second disk is adjustable by traversing any one or more of the first drive wheel, the second wheel, the in-coming wheels, and the out-going wheels.

24. The device according to any one of claim 17 to claim 23, wherein any one or more of the drive wheels are adapted to tilted toward or backward.

25. The device according to any one of claim 17 to claim 24, further comprising an electronic control system for holding any one or more of the drive wheels in a correct orientation.

26. The device according to any one of claim 17 to claim 25, wherein the first drive wheel is geared onto a geared drive disk.

27. The device according to claim 17, wherein a distance between the first drive wheel and the second drive wheel is less than a distance between the centre of the first drive disk and the centre of the second drive disk.

28. The device according to claim 17, wherein the first drive wheel is connected to a second drive wheel with a drive shaft comprising a plurality of two or more coupling rods attached to one another with a hinge, such that each of the coupling rods is adapted to move independently in such a way as to hold a constant a rotation ratio when the vehicle wheel moves up and down due to suspension.

29. The device according to claim 17, wherein the first drive wheel is connected to a second drive wheel with a drive shaft comprising two coupling rods for adjusting a rotational speed of the second drive disk by moving one of the two coupling rods in an arc around the second disk.
